(19) United States
(12) Patent Application Publication
(10) Pub. No.: US 2003/0200058 A1
(43) Pub. Date: Oct. 23, 2003

(54) Maintenance system

(76) Inventors: Kenji Ogawa, Osaka (JP); Yukio Kawamura, Osaka (JP); Keiji Ito, Osaka (JP); Haruyo Tamura, Osaka (JP)

Correspondence Address: D. PETER HOCHBERG CO. L.P.A., 1940 EAST 6TH STREET, CLEVELAND, OH, 44114, US

(21) Appl. No.: 10/413,241

(22) Filed: Apr. 14, 2003

(30) Foreign Application Priority Data
Apr. 17, 2002 (JP) 2002-114048

(51) Int. Cl. G06F 11/30

(52) U.S. Cl. 702/184

(57) ABSTRACT

A maintenance system includes: a maintenance terminal device having a head-mount display having a display, an audio communication device and a CCD camera, and a portable computer connected to the head-mount display; a monitoring and controlling unit provided in a monitoring room and having a control computer for controlling plant equipment and a control panel connected to the computer for monitoring the plant equipment; and a communication link for wirelessly connecting the monitoring and controlling unit with the maintenance terminal device. The system further includes a remote control function enabling the control panel to be operated with the maintenance terminal device, and a conferencing function enabling voice communication between a maintenance worker and a monitoring worker and enabling an image captured by the CCD camera to be displayed on an image display device provided in the control panel.

### FIELD OF THE INVENTION

The present invention relates to a maintenance system for performing maintenance work such as inspections and services or the like of each kind of equipment in plants such as manufacturing factories and incineration plants or the like by means of portable terminals having a wearable personal computer.

### BACKGROUND OF THE INVENTION

In maintenance work such as inspections and services or the like of each kind of equipment in a plant such as a manufacturing factory and an incineration plant or the like, maintenance workers commonly walk from site to site in the plant to visually inspect operations of the equipment.

On the other hand, along with remarkable advances in a microprocessor technology in recent years, information terminal systems for maintenance have been proposed that provide process operation data by using portable information terminals. With such an information terminal system, a maintenance worker performs maintenance while looking at operation data displayed on a portable information terminal on sites where different pieces of equipment to be maintained are installed.

However, with such an information terminal system, the maintenance worker must perform different operations directly on different pieces of equipment to be maintained while looking at operation data on the portable information terminal.

That is to say, there are drawbacks to these information terminal systems that efficiency of the maintenance work is low as compared with maintenance work performed collectively by an operator monitoring control panel provided in a central monitoring room and the amount of operation data obtained through the portable information terminal is limited as compared with data that can be obtained in the central monitoring room, preventing sophisticated maintenance.

### DISCLOSURE OF THE INVENTION

Therefore, an object of the present invention is to provide a maintenance system that improves the efficiency of maintenance and enables sophisticated maintenance.

To attain the object, the present invention provides a maintenance system for performing maintenance work on equipment provided in a plant having a monitoring room, including: a maintenance terminal device having a head-mount display including at least an image display device, an audio communication device, and a camera and a portable computer connected to the head-mount display; a monitoring and controlling unit that is provided in the monitoring room and has a control computer for controlling the equipment and a control panel connected to the control computer for monitoring the equipment; and a communication link for wirelessly connecting the monitoring and controlling unit with the maintenance terminal device, in which at least the portable computer is provided with a remote control function enabling the control panel of the monitoring and controlling unit to be operated from the maintenance terminal device; and the maintenance terminal device and the monitoring and controlling unit are provided with a conferencing function enabling voice communication between a maintenance worker and a monitoring worker and enabling an image captured by at least the camera of the maintenance terminal device to be displayed on an image display device provided in the control panel.

The maintenance system described above makes available to the maintenance worker through the remote control function the same monitoring and control functions as those available in the monitoring control panel provided in the monitoring room through the maintenance terminal device, thereby improving the efficiency of on-site maintenance work. In addition, the worker can obtain in real time the same operation data as that obtainable in the monitoring room and accordingly can perform sophisticated maintenance work.

Furthermore, in a preferred embodiment of the present invention, the head-mount display of the maintenance system is of an overhead-glass-type wearable over eyeglasses or a type that can be attached to dustproof glasses, and the image display device provided in the head-mount display is located at a position not obstructing a worker's view in front.

Various features and advantages of the present invention will be apparent from the following description of a preferred embodiment with reference to the accompanying drawings.

### BRIEF DESCRIPTION OF THE DRAWINGS

FIG. 1 is a diagram schematically showing a configuration of a maintenance system according to an embodiment of the present invention;

FIG. 2 is a block diagram schematically showing a configuration of a maintenance terminal device in the system;

FIG. 3 is a front view showing an outside appearance of a control panel of a monitoring and controlling unit in the system;

FIG. 4 is a front view schematically showing an HMD of the maintenance terminal device in the system; and

FIG. 5 is a flowchart for illustrating an operation with the system.

### DESCRIPTION OF THE EMBODIMENT

A maintenance system according to an embodiment of the present invention is designed for performing highly efficient maintenance work by using a portable maintenance terminal device having at least a head-mount display to inspect and service equipment (hereinafter referred to as plant equipment) such as valves and measuring instruments or the like in a plant such as an incineration plant that has a monitoring room.

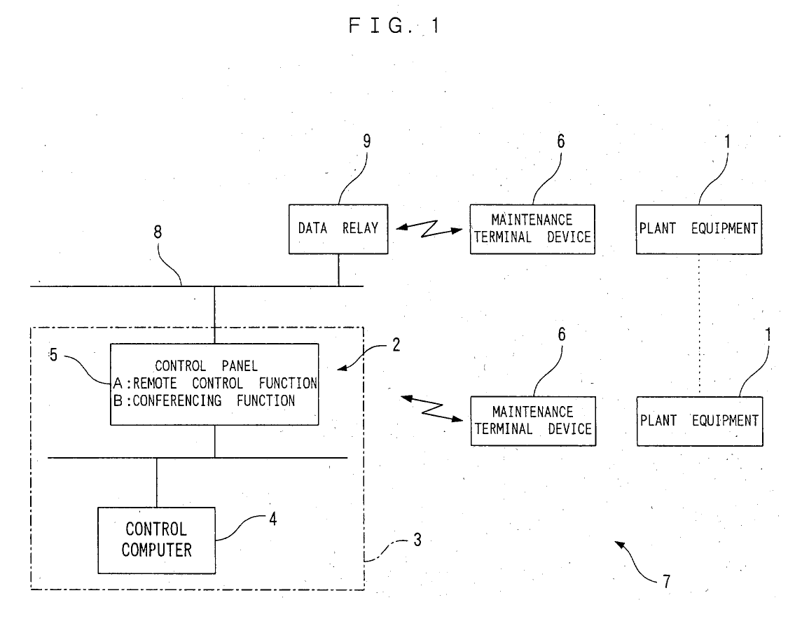

A monitoring and controlling unit 2 is provided in, for example, a central monitoring room 3 in the plant for monitoring and controlling various pieces of plant equipment 1, as shown in FIG. 1.

The monitoring and controlling unit 2 comprises a control computer (in particular, a distributed digital control system) 4 for monitoring and controlling operational conditions of plant equipment 1 and a monitoring control panel connected to the control computer 4 for monitoring and operating the plant equipment 1.

Further provided in the plant is a maintenance system 7 that allows a maintenance worker (hereinafter sometimes referred to as a worker) on a site to perform the same control functions as those available with the control panel 5 through a maintenance terminal device 6 carried by the worker during maintenance of the plant equipment 1.

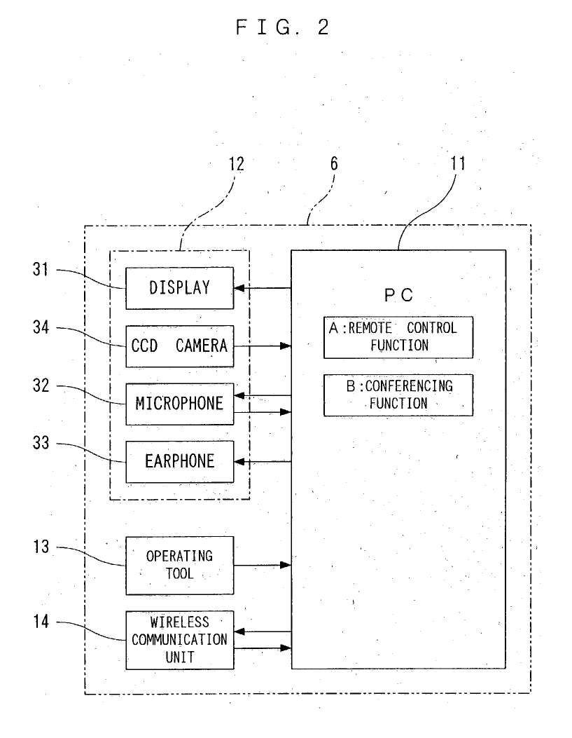

The maintenance system 7 consists of the maintenance terminal device 6 comprising at least a wearable personal computer (portable computer) 11, a goggle-like head-mount display (hereinafter abbreviated to HMD) 12 connected to the personal computer 11, an operating tool 13 such as a pointing device or the like for operating the personal computer 11, and a wireless communication unit 14 for wirelessly communicating with external devices and a data relay 9 connected with the control panel 5 through a high-speed communication data link 8 for wirelessly exchanging data with the maintenance terminal device 6, as shown in FIGS. 1 and 2. The data link 8 and data relay 9 and the wireless communication unit 14 of the maintenance terminal device 6 constitute a wireless communication link. The HMD 12 may be an overhead-glass-type HMD wearable over glasses or one that can be attached to dustproof glasses in consideration of wearability by the worker.

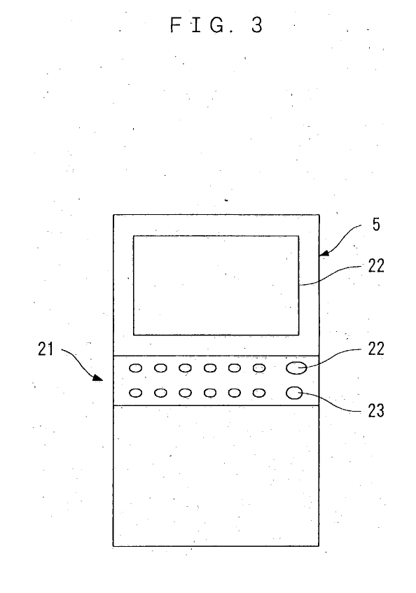

As shown in FIG. 3, the control panel 5 comprises at least a console 21 having operation buttons, a display (image display device) 22 incorporated in the console 21, and a microphone 23 and a speaker 24 provided in the console 21 as voice communication devices (including those that can communicate audio signals besides voice).

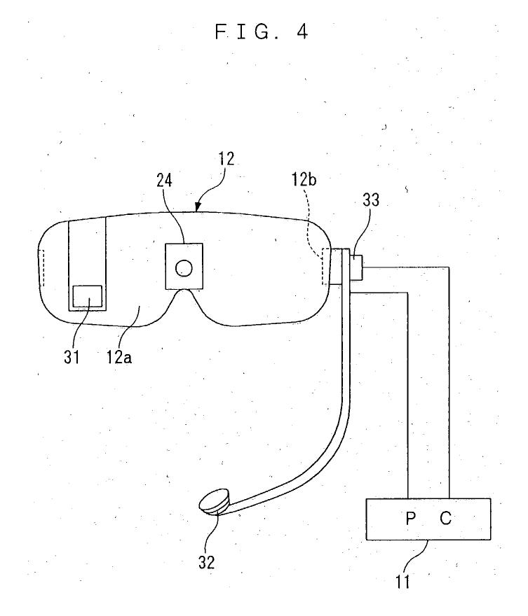

The HMD 12 of the maintenance terminal device 6 comprises, for example, a display (image display device) 31, which may be a liquid-crystal display, a microphone 32 and an earphone (which may be a small speaker) 33 which are voice communication devices (including those that can communicate audio signals besides voice), and a CCD camera for capturing a front view (which may be an imaging device such as a CMOS camera) 34 as shown in FIGS. 2 and 4.

The display 31 is positioned near the bottom (or on a side) of one lens 12a of the two lenses of the HMD 12 so as not to obstruct the worker's view. The microphone 32 is supported by a sidepiece 12b of the HMD 12 and the earphone 33 is also attached to the sidepiece 12b of the HMD 12.

The maintenance system 7 includes a remote control function (also referred to as a remote desktop function and include browsing function) A that enables the control panel 5 to be operated from the maintenance terminal device 6 and an online conferencing function B that enables conversation, i.e. conferencing, between the worker using the maintenance terminal device 6 and a monitoring worker in the central monitoring room 3, with looking at video images. In particular, both of the control panel 5 in the monitoring and controlling unit 2 and the maintenance terminal device 6 (more exactly, the personal computer 11) include software for implementing the remote control function A and conferencing function B. Of course, the personal computer 11 of the maintenance terminal device 6 controls the entire HMD 12, including the microphone 32 and earphone 33.

The control panel 5 also includes a function (interlock function) for determining whether or not it should allow the maintenance terminal device 6 to use and operate the remote control function and a firewall for preventing unauthorized access from an external person.

The conferencing function B and remote control function A will be briefly described below.

The conferencing function B enables wireless conversation (through the microphone 23, speaker 24, microphone 32, and earphone 33) between the control panel 5, which is a parent station, in the central monitoring room 3 and one or more maintenance terminal devices 6, which are child stations, interconnected by wireless, and displays on the display 22 of the control panel 5 in the central monitoring room 3 the video image of a site captured (during patrol) by the CCD camera 34 provided in the HMD 12. The conferencing function in the central monitoring room 3 may be provided in a separate device (for example a computer) other than the control panel 5.

The remote control function A enables the console 21 of the control panel 5 which is the parent station, in the central monitoring room 3, to be monitored in real time at one or more maintenance terminal devices 6, which are the child stations, and interconnected by wireless with the control panel 5, and enables the operating tool 13 in the personal computer 11 of the maintenance terminal device(s) 6 to be operated instead of an operating tool such as a track ball provided in the console 21.

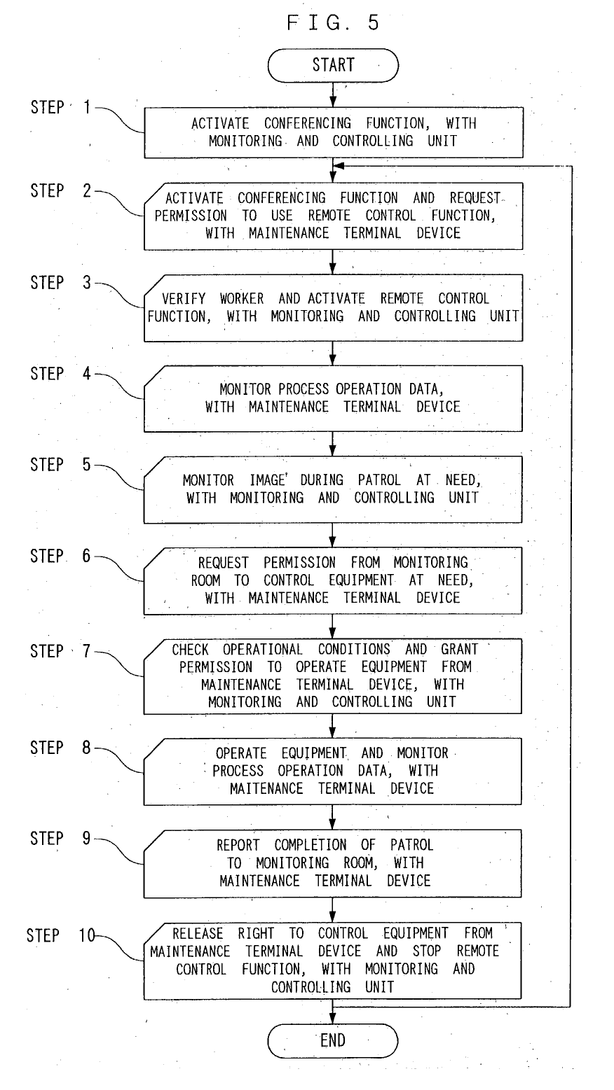

Next, maintenance work in the plant using the maintenance system will be described below with reference to the flowchart shown in FIG. 5.

In case of operating the maintenance system 7, the conferencing function in the central monitoring room 3, that is, in the control panel 5 is activated as shown in step 1.

When a worker wearing the maintenance terminal device 6 goes on patrol around the plant and performs maintenance work on plant equipment 1, he or she activates the conferencing function on the maintenance terminal device 6, then requests permission from the central monitoring room 3 to use the remote control function through the conferencing function, as shown in step 2.

Next, as shown in step 3, if the worker is verified, a monitoring person in the central monitoring room 3 activates the remote control function on the control panel 5.

Next, as shown in step 4, when the worker starts up the remote control function in the maintenance terminal device 6, process operation data (this data is stored in the control computer) about the plant equipment 1 is read from the control panel 5 and displayed on the display 31. This allows the worker to monitor the equipment 1. Of course, a number of monitoring screens are provided for different pieces of plant equipment 1 and can be selected from the maintenance terminal device 6.

Next, video images from the CCD camera 34 of the maintenance terminal device 6 are displayed on the display 22 of the control panel 5 through the conferencing function, as shown in step 5. This allows the monitoring person to monitor the equipment 1.

Next, if the worker wants to operate the plant equipment 1 through the maintenance terminal device 6, he or she requests through the conferencing function permission to remotely control the plant equipment 1, as shown in step 6.

Operational conditions of the plant equipment 1 are checked on the control panel 5 in the central monitoring room 3. If it is judged that operating the plant equipment 1 on the site will cause no problems, permission to operate the equipment 1 with the maintenance terminal device 6 is granted, as shown in step 7.

Next, as shown in step 8, the worker monitors and operates the plant equipment 1 with the maintenance terminal device 6 using the operating tool 13 connected to the personal computer 11 as if he or she were monitoring and controlling the plant equipment 1 by operating the control panel 5.

When the maintenance work is completed, the central monitoring room 3 is notified of the completion, as shown in step 9. Then, the right to control the equipment is released by the monitoring worker in the central monitoring room 3, and the remote control function is stopped, as shown in step 10.

The process described above is repeated for each maintenance job.

The arrangement of the maintenance system described above can make available to the worker wearing the maintenance terminal device 6 and patrolling sites, the same screen display and operability as those available on the control panel 5 in the central monitoring room 3. As a result, the efficiency of maintenance work on the site can be improved. In addition, because the worker can obtain, in real time on the site, the same process operation data that is available in the central monitoring room and accordingly can perform highly sophisticated maintenance work.

Furthermore, because the CCD camera 34, provided in the head-mount display together with the conferencing function, can display the video images of sites on the display 22 of the control panel 5 in the central monitoring room 3 during patrol and enable conversation between the on-site worker and the monitoring worker at need, the monitoring worker in the central monitoring room 3 can obtain in real time the visual and audio information during the patrol and therefore readily monitor the maintenance work performed by the patrolling worker.

While the maintenance terminal device in the embodiment described above has the function of remotely controlling the control panel in the central monitoring room and the function of monitoring process operation data on the control panel, various other general-purpose application software programs, such as an electronic filing system and plant maintenance and management system, may be installed in the personal computer of the maintenance terminal device at need, thereby enabling more sophisticated maintenance work.

In particular, drawings and instruction manuals of plant equipment installed in the plant may be stored in an electronic filing system, thereby allowing workers to reference them while they are patrolling the plant. Thus, the workers can perform efficient and versatile maintenance work.

1. A maintenance system for performing maintenance work on equipment provided in a plant having a monitoring room, comprising:
a maintenance terminal device having a head-mount display including at least an image display device, an audio communication device and a camera, and a portable computer connected to said head-mount display;
a monitoring and controlling unit that is provided in said monitoring room and having a control computer for controlling said equipment and a control panel connected to said control computer for monitoring said equipment; and
a communication link for wirelessly connecting said monitoring and controlling unit with said maintenance terminal device,
wherein at least said portable computer is provided with a remote control function enabling said control panel of said monitoring and controlling unit to be operated with said maintenance terminal device; and
said maintenance terminal device and said monitoring and controlling unit are provided with a conferencing function enabling voice communication between a maintenance worker and a monitoring worker and enabling at least an image captured by the camera of said maintenance terminal device to be displayed on the image display device provided in said control panel.

2. The maintenance system according to claim 1,
wherein said head-mount display is of an overhead-glass-type that is wearable over eyeglasses or a type that can be attached to dustproof glasses, and
said image display device provided in said head-mount display is located at a position not obstructing a worker's view in front.
